(19) United States
(12) Patent Application Publication
(10) Pub. No.: US 2009/0290206 A1
(43) Pub. Date: Nov. 26, 2009

(54) OPTICAL WAVEGUIDE DEVICE

(75) Inventor: Masaki SUGIYAMA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited.

(21) Appl. No.: 12/536,955

(22) Filed: Aug. 6, 2009

Related U.S. Application Data
(63) Continuation of application No. PCT/JP2007/055398, filed on Mar. 16, 2007.

(51) Int. Cl. G02F 1/225

(52) U.S. Cl. 359/254

(57) ABSTRACT

The present optical waveguide device, which improves the optical phase rotation efficiency with respect to activation voltage, includes: a substrate having electro-optic effects; a Mach-Zehnder optical waveguide formed on the substrate; and a signal electrode. The signal electrode is formed in an integrated manner such that an electric signal for applying the electric field travels from an upper part of either one of the two interference optical waveguides, which form the Mach-Zehnder optical waveguide, to an upper part of the other one of the two, and also, a periodical polarization characteristics region, in which regions opposite to each other in polarization are alternately arranged, being provided for a part of the other one of the interference optical waveguides on the substrate.

### CROSS-REFERENCE TO RELATED APPLICATION

This application is a Continuation Application of a PCT international application No. PCT/JP2007/055398 filed on Mar. 16, 2007 in Japan, the entire of contents which are incorporated by reference.

### FIELD

The embodiments disclosed herein relate to an optical waveguide device having a Mach-Zehnder optical waveguide, suitable for use as an optical modulator used for optical communications, optical arithmetic operations, and light signal controlling.

### BACKGROUND

An optical waveguide device using an electro-optic crystal, such as a lithium niobate (LiNbO3) substrate and a LiTaO2 substrate, is formed after an optical waveguide is formed by forming a metallic film on a part of the crystal substrate and performing thermal diffusion, or by means of performing proton exchange in benzoic acid after patterning performed, and by forming an electrode in the vicinity of the optical waveguide. Then, by means of forming an electrode for giving refraction index change to the light propagating through the optical waveguide, it is possible to construct an optical device performing optical modulation.

Such an electro-optical modulator using a ferroelectric material, such as lithium niobate (LiNbO3), has already been put to practical use, including the optical communications system, and high-velocity optical modulators that are capable of modulating a light wave at a high-frequency electric signal of about 40 GHz, for example, have been carried forward in being put into the market.

FIG. 16 is a diagram, viewed from the top, illustrating a clock modulator 100, as an example of the above described high velocity optical modulator, used in the CS-RZ (Carrier Suppressed RZ) modulation scheme or the like. The clock modulator 100 illustrated in FIG. 16 includes: a z-cut substrate (LN substrate) 101 make of, for example, lithium niobate, which is electro-optical crystal; an optical waveguide device 100A on the LN substrate 101 including a Mach-Zehnder optical waveguide 102, a signal electrode 103, and ground electrodes 104; and a clock signal source 105, which generates a (high-velocity) clock signal to be supplied from the upstream side of the optical propagation direction of the signal electrode 103.

The Mach-Zehnder optical waveguide 102, which is integrally formed by, for example, an input optical waveguide 102a, two interference optical waveguides 102b, and an output optical waveguide 102c, is constructed, as a coplanar electrode, with the signal electrode 103 and the ground electrode 104. In such a case of the clock modulator 100 of FIG. 16 where the z-cut substrate 101 is used, the refraction index change caused by the electric field in the Z direction. Thus, generally speaking, the signal electrode 103 and the ground electrodes 104 are arranged over the Mach-Zehnder optical waveguide 102b.

Further, the above described patterning of the signal electrode 103 and the ground electrodes 104 is performed on the interference optical waveguide 102b, and a buffer layer (not illustrated) is interposed between the substrate 101 and the signal electrode 103 and the ground electrodes 104 for preventing the light propagating through the Mach-Zehnder optical waveguide 102b from being absorbed by the ground electrodes 104. As a buffer layer, SiO2 with a thickness of 0.2 μm through a thickness of 1 μm is used.

In a case where the clock modulator 100 with the above described construction is activated in high velocity, the terminals of the signal electrode 103 and the ground electrodes 104 are coupled together with resistors, which realize a proceeding wave electrode, and a microwave signal is applied from the light input end. At that time, the refraction indexes of the two interference optical guides 102b are changed into +Δna and −Δnb due to the electric field change caused by supplying the electric signal of a microwave from the clock signal source 105 through the signal electrode 103 and the ground electrodes 104.

This changes the phase difference of light due to periodical change in electric field in the process, in which the light input to the input light waveguide 102a is divided into two pieces of light propagating through the two interference optical waveguides 102b, so that the signal light which is subjected to intensity modulation is output from the output optical waveguide 102c.

In this instance, the capability of controlling the effective refraction index of a microwave by means of changing the cross-sectional shapes of the electrodes 103 and 104 is already known, and the capability of obtaining the light response characteristic in the broadband optical response characteristic obtained by matching the velocity of the light with that of the microwave.

Further, as the technology relating to the present invention, the technology described in the following patent documents 1 through 3 exists.

Patent Document 1: Japanese Patent Application Publication No. 2003-228033

Patent Document 2: Japanese Patent Application Publication No. HEI 9-23783

Patent Document 3: Japanese Patent Application Publication No. 2005-128531

In a Mach-Zehnder optical modulator, the amplitude of the electric signal applied to the electrode, that is, lowering of activation voltage, has previously been an important issue. Thus, the electric field for modulating light is required to be efficiently supplied.

However, in a case where the already described CS-RZ, for example, is employed as a modulation scheme, the activation voltage of two-fold Vπ is required. In this case, a larger activation voltage is required in comparison with a case in which an activation voltage of Vπ is used with another activation scheme. Thus, it is further demanded to increase the light modulation efficiency with respect to the applied electric signal, that is, to efficiently supply the electric field to the optical waveguide.

FIG. 17 illustrates a construction in which the signal electrode 103 is formed in an upper part of one of the two interference optical waveguides 102b, similar to the already described clock modulator 100 in FIG. 16, and in which the ground electrodes 104 are formed in an upper part of the other one of the interference optical waveguides 102b. In FIG. 17, the electric field intensity applied to the two interference optical waveguides 102b, which is a microwave component in a case where an electric signal equivalent to the peak component of a sign wave forming a microwave, is supplied from the clock signal source 105, is illustrated in accordance with the light propagation position in the interference optical waveguide 102b.

As to a microwave component at the time the microwave signal with an electric intensity of “1” is supplied from the clock signal source 105, an electric field in a downward direction (in the direction of the rear side-oriented substrate 101 from the signal electrode 103) with respect to the interference optical waveguide 102b (waveguide A) which is present in a lower part of the signal electrode 103, becomes dominant, and the size thereof becomes the largest according to the applied voltage. In this instance, the peak component of a sign wave forming this microwave proceeds toward the terminal position of the signal electrode 103 thereafter. Under the effects of the microwave attenuation due to the skin effects or the like accompanying this procession, the electric field intensity given to the interference optical waveguide 102b at the lower part of the signal electrode 103 decreases.

In contrast to this, since a part of the electric force line from the signal electrode 103 to the waveguide A reaches the waveguide B, the direction of dominant electric field in the interference optical waveguide 102B becomes opposite to that of waveguide A. And the size thereof becomes smaller than that which is given to the waveguide A, and becomes one-fifth of the electric intensity which the waveguide A is given, as illustrated in FIG. 17, for example.

In other words, since the refraction index change in the interference optical waveguide 102b is proportional to the electric filed intensity supplied to the signal electrodes 103 and 104, the phase change amount due to the refraction index change generated in the waveguide A is (−⅕) of the phase change amount due to refraction index change generated in the waveguide B.

As to such a matter, if the size (amplitude) of an electric signal supplied by the signal electrode 103 is maintained as it is, the change of the waveguide B, that is, the electric field given to the interference optical waveguide 102b formed in the lower part of the ground electrodes 104 is increased, the phase change amount of the light can be relatively increased, so that it is possible to improve the optical modulation efficiency with respect to the supplied electric signal.

### SUMMARY

(1) As a generic feature, there provided is an optical waveguide device, comprising: a substrate having electro-optic effects; a Mach-Zehnder optical waveguide formed on the substrate; and a signal electrode formed on the substrate, which signal electrode applies electric field to the Mach-Zehnder optical waveguide, the signal electrode being formed in an integrated manner such that an electric signal for applying the electric field travels from an upper part of one of two interference optical waveguides, which form the Mach-Zehnder optical waveguide, to an upper part of the other one of the interference optical waveguides, and a periodical polarization characteristics region, in which regions opposite to each other in polarization are alternately arranged, being provided for a part of the other one of the interference optical waveguides on the substrate.

(2) As a preferred feature, in the above described case (1), the signal electrode comprises: a first electrode unit formed at the upper part of the one of the interference optical waveguides, in which first electrode unit the electric signal proceeds in a first direction; a second electrode unit formed at the upper part of the other one of the interference optical waveguides, in which second electrode unit the electric signal proceeds in a second direction that is opposite to the first direction; and a third electrode unit which couples a down stream position in the direction in which the electric signal proceeds to an upstream position in the direction in which the electric signal proceeds in the second electrode unit.

(3) As another preferred feature, the periodical polarization characteristics region is constructed in such a manner that a first polarization region with first polarization characteristic and second polarization region with second polarization characteristic, which is opposite to the first polarization characteristic, are alternately arranged over the substrate on which the other one of the interference optical waveguides is formed.

(4) As yet another preferred feature, in the above described case (3), the length of the first or the second polarization region in the most downstream part in the optical propagation direction in the other one of the interference optical waveguides is substantially half the length of each polarization region formed in an upper stream part in the optical propagation direction than the polarization region.

(5) As a further preferred feature, in the above described case (3), if a construction thereof is given such that an electric signal at a frequency of f, as the electronic signal, is supplied to the signal electrode, and assuming that the velocity of light propagating through the other one of the interference optical waveguides is Vo and also that the velocity of light propagating through an upper part of the other one of the interference optical waveguides in the signal electrode is Vm and also that the distance between the two interference optical waveguides is Li, the substantial length of a polarization region in the most downstream part in the optical propagation direction in the other one of the interference optical waveguides is given as VoVm/(4(Vm+Vo)f)−Li, and the substantial length of each polarization region formed in an upper stream part of the optical propagation direction than the polarization region in the most downstream part in the optical propagation direction is given as VoVm/(2(Vm +Vo)f)

(6) As a yet further preferred feature, in the above described case (3), the sum of the lengths of the polarization regions with the first polarization characteristic or the lengths of the polarization regions with the second polarization characteristic, which forms the periodical polarization characteristic region, is substantially half the length of the other one of the interference optical waveguides.

(7) As a still further preferred feature, in the above described case (1), a construction thereof is given as an RZ light pulse modulator, which generates an RZ light pulse having a frequency equivalent to the frequency of the electric signal or the frequency double the electronic signal by modulating input light.

(8) As another preferred feature, in the above described case (3), if a construction thereof is given such that an electric signal at a frequency of f, as the electronic signal, is supplied to the signal electrode, and assuming that the velocity of light propagating through the other one of the interference optical waveguides is Vo and also that the velocity of light propagating through an upper part of the other one of the interference optical waveguides in the signal electrode is Vm, the periodical polarization region has a construction such that the substantial lengths of the polarization regions in the most downstream part and the most upstream in the optical propagation direction in the other one of the interference optical waveguides is VoVm/(4(Vm+Vo)f), and the length of each polarization region arranged in the other one of the interference optical waveguides, from a downstream part thereof in the optical propagation direction to an upstream part thereof, is distributed between VoVm/(2 (Vm+Vo)(f+df)) and VoVm/(2(Vm+Vo)(f−df)) based on a frequency variation df of an electronic signal supplied as the electronic signal.

(9) As a further preferred feature, in the above described case (1), a construction thereof is given such that the velocity of an electric signal propagating through an upper area of the other one of the interference optical waveguides in the signal electrode is changed in the optical propagation direction of the other one of the interference optical waveguides.

(10) As a yet further preferred feature, in the above described case (12), assuming that the periodical cycle of the polarization characteristic which the periodical polarization characteristics region has is Ldi, the velocity of the electric signal varies between 2Ldi (f−df)Vo/(Vo−2Ldi (f−df)) and 2Ldi (f+df)/Vo(Vo−2Ldi(f+df)) based on the frequency variation df of the electric signal.

(11) As a still further preferred feature, in the above described case (9), ground electrodes formed at specific intervals along the exterior fringe of the signal electrode are provided for the substrate, and the width of the interval between the signal electrode and the ground electrodes has a shape which changes in the optical propagation direction.

(12) As another preferred feature, in the above described case (9), the region of the signal electrode formed in an upper part of the other one of the interference optical waveguides is constructed in such a manner that the thickness and the width of the region in the optical propagation direction change in the optical propagation direction.

(13) As yet another preferred feature, in the above described case (9), a buffer layer is interposed between the substrate and the signal electrode and also the thickness of a region between the other one of the interference optical waveguides and the signal electrode varies in the optical propagation direction in the other one of the interference optical waveguides.

(14) As still another preferred feature, in the above described case (9), a ridge waveguide is provided as the interference optical waveguide of the one of the interference optical waveguides by forming grooves on both sides of the one of the interference optical waveguides on the substrate, and the grooves are made in such a manner that the width of the ridge waveguide varies in the optical propagation direction.

(15) As a further preferred feature, in the above described case (1), ground electrodes formed at specific intervals along the exterior fringe of the signal electrode are provided for the substrate.

(16) As a yet further preferred feature, in the above described case (15), a distance between the two interference optical waveguides is made to be three times or more that of the specific interval between the signal electrode and the ground electrodes.

(17) As a still further preferred feature, in the above described case (15), the ground electrodes are formed in a region sandwiched between the two interference optical waveguides and in outer regions of the two interference optical waveguides, and also, the region sandwiched between the two interference optical waveguides are coupled to the outer regions of the two interference optical waveguides by bonding.

(18) As another preferred feature, in the above described case (1), the signal electrode has an electric signal input terminal through which the electronic signal is input to the one of the interference optical waveguides, and also, an electric signal output terminal which outputs the electric signal that travels through the other one of the interference optical waveguides, and also, the electric signal input terminal and the electric signal output terminal are arranged on one side of the substrate.

(19) As yet another preferred feature, in the above described case (1), the signal electrode comprises: a fourth electrode unit in which the electric signal proceeds in an upper part of the other one of the interference optical waveguides in a first direction; a fifth electrode unit, formed in the upper part of the one of the interference optical waveguides, in which the electric signal proceeds in the first direction; a sixth electrode unit which couples a proceed direction downstream position in the electric signal in the fourth electrode unit and a proceed direction upstream position of the electric signal in the fifth electrode unit together; a seventh electrode unit, formed on the position depart from the position at which the fourth electric unit in an upper part of the other one of the interference optical waveguides, in which the electric signal proceeds in a second direction, which is opposite to the first direction; and an eighth electrode unit which connects a proceed direction downstream position of the electric signal in the sixth electrode unit and a proceed direction upstream position of the electric signal in the seventh electrode unit together and also regions on the substrate at which the fourth electrode unit and the fifth electrode unit are formed as regions having polarization characteristics opposite with respect to one another, and the periodical polarization characteristics region is provided for a region on the substrate at which the seventh electrode unit is formed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram, viewed from the top, illustrating an optical waveguide device according to a first embodiment of the present invention;

FIG. 2 is a diagram for describing effects and benefits of the first embodiment;

FIG. 3 is a diagram for describing a construction of a periodic polarization characteristics region according to the first embodiment;

FIG. 4 is a diagram for describing effects and benefits from a periodic polarization characteristics region according to the first embodiment;

FIG. 5 is a diagram, viewed from the top, illustrating an optical waveguide device according to a second embodiment of the present invention;

FIG. 6 is a diagram for describing effects and benefits of the second embodiment;

FIG. 7 is a diagram illustrating a modified example of the optical waveguide device according to the second embodiment;

FIG. 8 is a diagram illustrating another modified example of the optical waveguide device according to the second embodiment;

FIG. 9 is a diagram illustrating yet another modified example of the optical waveguide device according to the second embodiment;

FIG. 10 is a diagram, viewed from the top, illustrating an optical waveguide device according to a third embodiment;

FIG. 11 is a diagram for describing effects and benefits of the third embodiment;

FIG. 12 is a diagram illustrating a modified example of the third embodiment;

FIG. 13 is a diagram for describing effects and benefits of the third embodiment;

FIG. 14 is a diagram illustrating a modified example of the third embodiment;

FIG. 15 is a diagram illustrating another modified example of the optical waveguide device according to the third embodiment;

FIG. 16 is a diagram illustrating a previous art; and

FIG. 17 is a diagram for describing effects of the previous art illustrated in FIG. 16.

### DESCRIPTION OF REFERENCE CHARACTERS

1, 10, 11, 11A through 11C . . . optical waveguide device
2 . . . substrate
3, 13 . . . . Mach-Zehnder optical waveguide
3a, 13a . . . input optical waveguide
3b-1, 3b-2, 13b-1, 13b-2 . . . interference optical waveguide
3c, 13c . . . output optical waveguide
31, 32, 34 . . . groove
33 . . . bonding wire
41, 43 . . . signal electrode
41a . . . first electrode unit
41b . . . second electrode unit
41c . . . third electrode unit
41-1, 41-2 . . . electrode pad
42, 44 . . . ground electrode
431 . . . electric signal input terminal
432 . . . electric signal output terminal
434 . . . fourth electrode unit
435 . . . fifth electrode unit
436 . . . sixth electrode unit
437 . . . seventh electrode unit
438 . . . eighth electrode unit
6, 16, 16A, 60 . . . periodic polarization characteristics region
6a, 16a, 61′, 61 . . . first polarization region
6b, 16b, 62 . . . second polarization region
7 . . . clock signal source
18, 18A, 19 . . . polarization inversed region
100 . . . clock modulator
100A . . . optical waveguide device
101 . . . substrate
102 . . . . Mach-Zehnder optical waveguide
102a . . . input waveguide
102b . . . interference optical waveguide
102c . . . output optical waveguide
103 . . . signal electrode
104 . . . ground electrode
105 . . . clock signal source

### DESCRIPTION OF EMBODIMENTS

Embodiments of the present invention will now be described with reference to the relevant accompanying drawings.

Here, the present invention should by no means be limited to the above-illustrated embodiment, and various changes or modifications may be suggested without departing from the gist of the invention. Further, not only the above described objects but also other technical issues, means for resolving the technical issues, and the effects and benefits of the present invention will be clarified.

### [a] First Embodiment

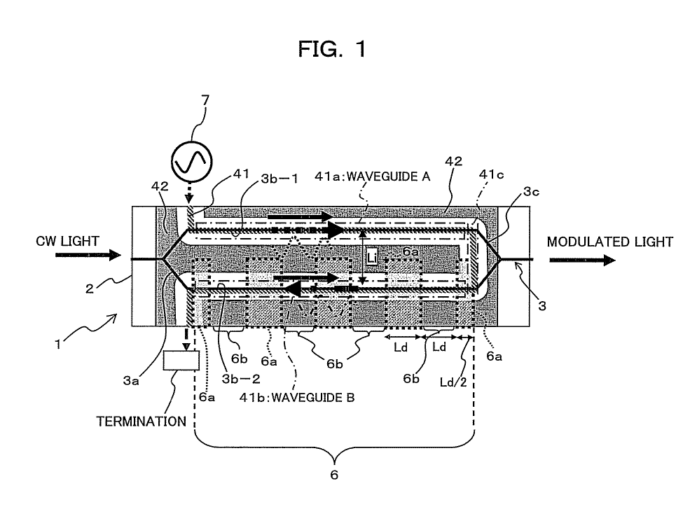

FIG. 1 is a diagram, viewed from the top, illustrating an optical waveguide device according to a first embodiment of the present invention.

An optical waveguide device 1 includes: a z-cut LN substrate 2, which is an electro-optic material; a Mach-Zehnder optical waveguide 3 formed on the LN substrate 2 by means of titanium diffusion or proton exchange; and electrodes 41 and 42 formed by way of a buffer layer (not illustrated). The electrode 41 changes the refraction index of a waveguide, formed on the LN substrate 2, through which light propagates with application of an electric signal for modulation. The ground electrodes 42 are formed along the outer fringe of the electrode 41 at specific intervals.

The Mach-Zehnder optical waveguide 3 has two interference optical waveguides 3b-1 and 3b-2 which propagate two pieces of light therethrough, respectively, and an output optical waveguide 3c which combines light from the two interference optical waveguides 3b-1 and 3b-2 and then outputs the combined light.

Here, the electrode 41 is formed in such an integrated and connected manner that an electric signal applied from a clock signal source 7 travels from the upper part of either one of the optical waveguides 3b-1 and 3b-2 (interference optical waveguide 3b-2 in a construction illustrated in FIG. 1) to the upper part of the other optical waveguide (the interference optical waveguide 3b-1 in the construction illustrated in FIG. 1). That is, the electrode 41 has the first electrode unit 41a through the third electrode unit 41c.

The first electrode unit 41a is formed at an upper part of the interference optical waveguide 3b-1, in which an electric signal from the clock signal source 7 proceeds in the first direction (in this case, the direction along the light propagation direction). Further, the second electrode unit 41b, which is formed in the upper part of the other interference optical waveguide 3b-2, and an electric signal from the clock signal source 7 proceeds in the second direction (in this case, in the direction opposite to the light propagation direction). Yet further, the third electrode unit 41c couples the downstream position in the traveling direction of the electronic signal, which forms the first electrode unit 41a and the upstream position in the traveling direction of the electronic signal, which is in the second electrode unit 41b, together.

With this arrangement, an electric signal supplied from the upstream side of the light propagation direction in the first electrode unit 41a travels in the first electrode unit 41a in a light propagation direction, and then travels in the second electrode unit 41b by way of the third electrode unit 41c.

Further, in the optical waveguide device 1 according to the first embodiment, a periodical propagation characteristics region 6 is provided for a part of the other interference optical waveguide 3b-2 in the LN substrate 2, in which regions with mutually inverse polarization characteristics are alternately arranged cyclically. That is, the periodical propagation characteristics region 6 has a construction in which the first polarization region 6a with the first polarization characteristic and the second polarization region 6b with the second polarization characteristic are alternately arranged over the region of the LN substrate 2 in which the other interference optical waveguide (waveguide B) 3b-2 is formed.

In this instance, in the first embodiment, the first polarization region 6a is formed at a position at which the second electrode unit 41b is coupled to the third electrode unit 41c, that is, the most downstream position in the light propagation direction in the interference optical waveguide 3b-2, and the first polarization region 6a arranged at that position, together with the same as the first polarization region 6a at the most upstream position in the light propagation direction in the interference optical waveguide 3b-2, has a length which differs from those of other first polarization regions 6a arranged at intermediate positions in the light propagation direction in the interference optical waveguide 3b-2.

The first polarization regions 6a are constructed so as to have the polarization characteristic opposite to that of other regions including the interference optical waveguide (waveguide A) 3b-1 and the second polarization region 6b of the LN substrate 2. For example, as to the first polarization region 6a, the subject regions in which the interference optical waveguide 3b-2 are inverted in polarization in the stage previous to that in which a buffer layer is provided, for example, after the above mentioned Mach-Zehnder optical waveguide 3 is formed on the LN substrate 2.

On the other hand, the second propagation regions 6b having the polarization characteristic opposite to that of the above described first polarization region 6a, have the polarization characteristic equivalent to that in other regions than the first polarization region 6a including the interference optical waveguide (waveguide A) 3b-1 of the LN substrate 2. In particular, the second propagation regions 6b indicate the regions sandwiched between the first polarization region 6a in the regions of the LN substrate 2 at which the interference optical waveguide (waveguide B) 3b-2 is formed.

The lengths of these first polarization region 6a and the second propagation region 6b are made to be those that match cyclical change in electric field caused by a relative velocity difference between the light propagating through the interference optical waveguide 3b-2 and the light propagating through the electric signal propagating through the second electrode unit 41b (in the direction opposite to the interference direction of light propagating through the interference optical waveguide 3b-2).

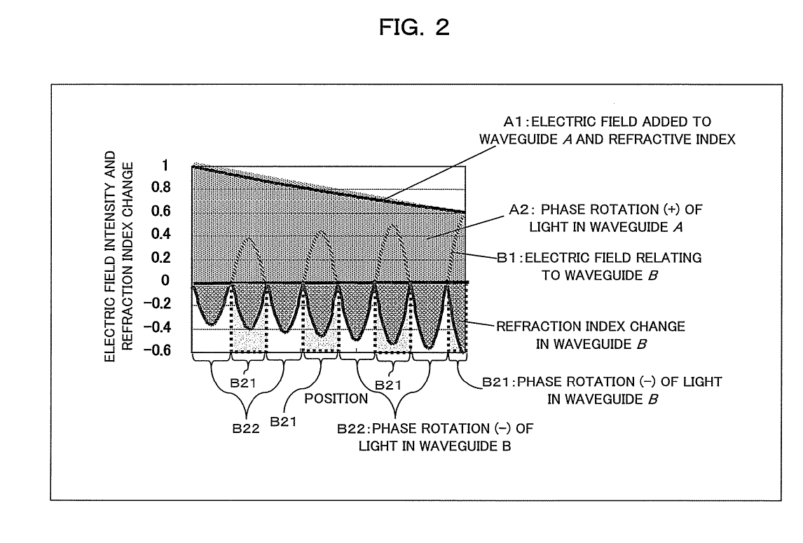

FIG. 2 indicates the electric field and the refraction index change of the light propagating through the interference optical waveguides 3b-1 and 3b-2, which change is caused by the electronic signal propagating in the electrode 41. The clock signal source 7 supplies a sign-wave electric signal, which is a microwave, and FIG. 2 pays an attention to the electric field given by the electric signal component equivalent to a peak component, proceeding in the electrode 41, according to the propagation positions in the interference optical waveguides 3b-1 and 3b-2.

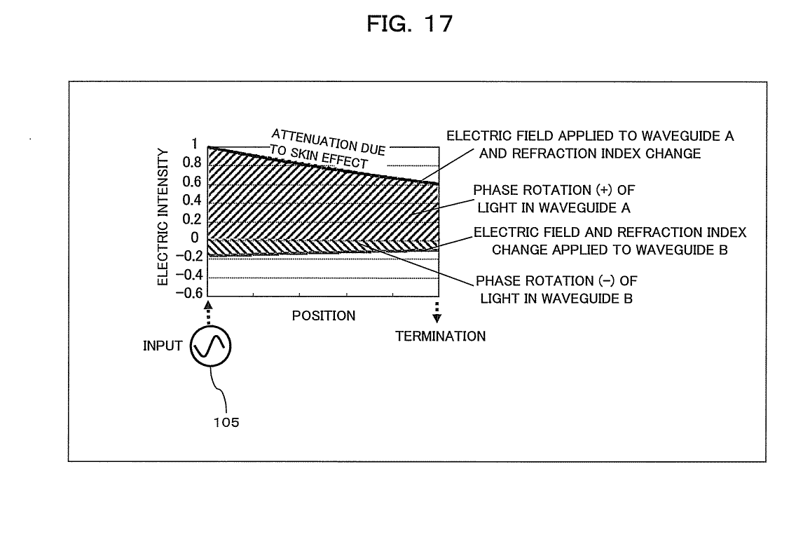

Here, a construction is given such that the velocity of the light propagating through the interference optical waveguide 3b-1 and the propagation velocity of the electric signal in the first electrode unit 41a, which forms the electrode 41, match each other in the same direction. As a result, although an attenuation component due to skin effect or the like, similar to the case already described with reference to FIG. 17, exists in the electric field given to the interference optical waveguide 3b-1, no change according to the microwave frequency accompanying light procession exists in the electric field given to the input light component (see reference character A1 in FIG. 2).

In contrast to this, an electric signal propagating in the upper part of the interference optical waveguide 3b-2 propagates in the direction opposite to that of the light propagating through the interference optical waveguide 3b-2. For this reason, as to the electric field given to the interference optical waveguide 3b-2, the regions (the regions which occupy the positions at which the refraction index change is larger than “0” in FIG. 2) in the direction equivalent to that of the electric field given to the interference optical waveguide 3b-1 and the regions (the regions which occupy the positions at which the refraction index change is smaller than “0” in FIG. 2) in the direction opposite to that of the region given to the interference optical waveguide 3b-1, appear alternately (see reference character B1 in FIG. 2).

Here, as to the direction of the electric field given to the light propagating through the interference optical waveguide 3b-2, in the field of the LN substrate 2 in which the interference optical waveguide 3b-2 is formed to make the propagation characteristic of the second polarization characteristic equivalent to the second polarization characteristic, makes it possible to make the phase change amount which is given to the light propagating through the interference optical waveguide 3b-2 can be made to be the minus direction, which is the direction opposite to the phase rotation direction (see reference character A2 in FIG. 2, the plus direction) given to the light propagating through the interference optical waveguide 3b-1, as indicated by reference character B22 in FIG. 2. This leads to improvement of the efficiency of the phase change.

On the other hand, in the region in the direction equivalent to the direction equivalent to that of the electric field given to the interference optical waveguide 3b-1, it is possible to make the phase rotation direction given to the light propagating through the interference optical waveguide 3b-2 the minus direction in the direction opposite to that of the phase change amount (see reference character A2 in FIG. 2, the plus direction) given to the light propagating through the interference optical waveguide 3b-1, as indicated by reference character B21 in FIG. 2. This leads to improvement of the efficiency of the phase change.

In other words, in the field of the LN substrate 2 in which the interference optical waveguide 3b-2 is formed, the second propagation region 6b whose polarization characteristic is opposite to that of the interference optical waveguide 3b-1 is formed, and also, in the region in which the first propagation region 6a whose polarization characteristic is equivalent to that of the interference optical waveguide 3b-1 is formed.

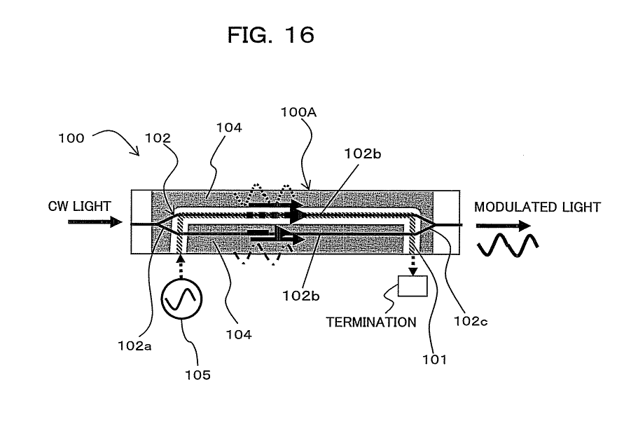

With this arrangement, in comparison with the case in FIG. 16 having the signal electrode 101 and the ground electrodes 104, the electric fields given to the light at the corresponding propagation positions with an electric signal applied to the electrode 41 are made to be opposite with respect to one another. As a result, it is possible to positively form electric fields by the electric lines of force from the electrodes 41 (41a and 41b) formed in the upper parts of both the two interference optical waveguides 3b-1 and 3b-2, so that the efficiency of the phase change is capable of being improved in comparison with the case indicated in FIG. 17 as a whole.

More precisely, assuming that the light propagation velocity (the absolute value thereof) is Vo, and also that the velocity (the absolute value thereof) of the electric signal proceeding in the second electrode unit 41b is Vm, the wavelength is λm, and the frequency is f, the length of each of the first polarization regions 6a and each of the second propagation regions 6b is set to be VoVm/2(Vo+Vm).

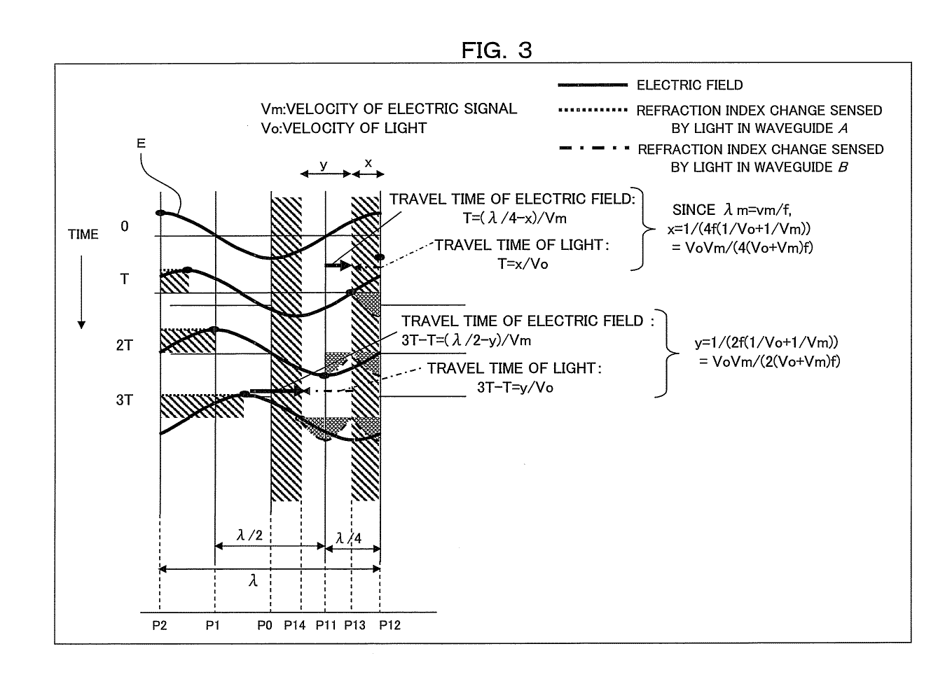

FIG. 3 is a diagram for describing derivation of the lengths of the first polarization region 6a and the second propagation region 6b. As illustrated in FIG. 3, assuming that as the time elapses from time “0” to time “3T” at equivalent time intervals, the electric signal (E) propagates in the first electrode unit 41a and the second₋electrode unit 41b, and light travels through each of the interference optical waveguides 3b-1 and 3b-2 at a propagation velocity of Vo.

In this instance, for easy description, as the propagation wavelength λ of the electric signal propagating in the upper part of the first electrode unit 41a of the interference optical waveguide 3b-1 and the above mentioned wavelength λm are sufficiently longer than the length (or the distance between the interference optical waveguides 3b-1 and 3b-2) Li, the propagation distance in the third electrode unit 41c (or the interference optical waveguides 3b-1 and 3b-2) and the phase change of the electric signal corresponding to the propagation distance are not taken into consideration. Further, the propagation length λ of the electric signal propagating in the first electrode unit 41a can be made to be substantially equivalent to the wavelength λm of the electric signal propagating in the second electrode unit 41b.

Here, in FIG. 3, the horizontal axis coordinate P0 corresponds to the most downstream terminal positions in the first and the second electrode units 41a and 41b; the horizontal axis coordinates P1 and P2 correspond to the positions apart from distances of a quarter (λ/4) and a half (λ/2) of the wavelength of the electric signal propagating through the first electrode unit 41a, respectively, in the upper stream light propagation direction. Likewise, the horizontal axis coordinates P11 and P12 correspond to the positions apart from distances of a quarter (λm/4) and a half (λm/2) of the wavelength of the electric signal propagating through the second electrode unit 41b, respectively, in the upper stream light propagation direction (or the downstream light propagation direction in the electric signal propagation direction).

As described above, as to the electric field given to the interference optical waveguide 3b-2 due to the propagation of the electric signal in the second electrode unit 41b in the field of the LN substrate 2 in which the interference optical waveguide 3b-2 is formed, the first polarization region 6a, whose propagation characteristic is opposite to that of the interference optical waveguide 3b-1, is formed in the region whose direction is the same as that given to the interference optical waveguide 3b-1.

For example, with an attention paid to a case in which a positive peak component of electric signal that forms a sign wave, the length of the first polarization region 6a is made to be the light propagation distance x, such that the sum of the propagation distance of the light propagating through the interference optical waveguide 3b-2 at time intervals T and the propagation distance of the light propagating in the second electrode unit 41b at the above mentioned time T is a quarter of a wavelength distance from a positive peak at which the electric signal level forms a sign wave to “0” (that is, the apparent phase change in change of the electric signal given to the light propagating through the interference optical waveguide 3b-2 is equivalent to a quarter of a wavelength), the length of the first polarization region 6a.

That is, the above mentioned time T can be given as T=(λm/4−x)/Vm by use of the propagation distance of an electric signal propagating in the second electrode 41b, that is, the travel distance (λm/4−x). On the other hand, by use of the propagation distance x of the light propagating through the interference optical waveguide 3b-2, the above mentioned time T can be given as T=x/Vo by use of the light propagation distance x propagating through the interference optical waveguide 3b-2. Since λm=Vm/f, by use of the above mentioned two formulae, x can be given as x=1/(4f(1/Vo+1/Vm)=VoVm/(4(Vo+Vm)f)=Ld/2.

In this instance, in FIG. 3, as the above mentioned x, the distance of the first polarization region 6a is derived as x which makes the apparent phase change of the electric signal change given to the light propagating through the interference optical waveguide 3b-2 to be equivalent to a quarter of a wavelength. In the range between the coordinates P14 and P0, also, in which the first polarization region 6a is practically formed, the derivation as the above mentioned x is capable of being performed.

Accordingly, in the second electrode unit 41b formed at the position to which the electric signal from the third electrode unit 41c is input, the first polarization region 6a-1 can be formed as the one to which a length practically of x=1/(4f(1/Vo+1/Vm)=VoVm/(4 (Vo+Vm) f)=Ld/2 is given from the coordinate position corresponding to the propagation start terminal of the electric signal in the second electrode unit 41b in the upstream direction of the light propagating through the interference optical waveguide 3b-2.

Further, the second propagation region 6b, partially formed in the field of the LN substrate 2 in which the interference optical waveguide 3b-2 is formed, has the same polarization characteristic as that of the region of optical waveguide 3b-1 and is applied an electric field opposite, in direction, to the interference optical waveguide 3b-1.

For this reason, the propagation distance y of the light is made to be the length of the second propagation region 6b-1 following the first polarization region 6a-1, such that the sum of the propagation distances of the light propagating through the interference optical waveguide 3b-2 till the elapse of the time 3T (time intervals are 2T) and the propagation distance of the electric signal propagating in the second electrode unit 41b becomes “0” once again from the “0” level thereof, by way of a negative peak at which the electric signal level forms a sign wave, that is, the distance equivalent to a half of a wavelength.

That is, by use of the propagation distance of the electric signal propagating in the second electrode unit 41b, that is, the travel distance of the electric field (λm/2−y), time (2T) from the above mentioned time “T” to the above mentioned time “3T” can be given as 2T=(λm/2−x)/Vm. On the other hand, by use of the propagation distance y of the light propagating through the interference optical waveguide 3b-2, the above mentioned time 2T can be given as 2T=y/Vo.

At that time, since λm=Vm/f, by use of the above mentioned two formulae, the following formula can be given: y=1/(2f(1/Vo+1/Vm)=VoVm/(2(Vo+Vm)f). This makes it possible to form the second propagation region 6b-1 whose substantial length is given as y=1/(2f(1/Vo+1/Vm)=VoVm/2(Vo+Vm)f)=Ld.

Likewise, the first polarization region 6a-2 of the upper stream light propagation direction of the second propagation 6b-1, is set to be the length such that the apparent phase change of the electric signal change given to the light propagating through the interference optical waveguide 3b-2 is equivalent to the length of a half of the wavelength from the level “0” to the level “0” (see reference character P13) by way of the positive peak (see reference character P12), that is, the length y=Ld similar to the above mentioned second propagation region 6b-1. Thereafter, the above second propagation regions 6b and the above first polarization regions 6a are alternately formed along the light propagation upstream direction in which the light propagates through the interference optical waveguide 3b-2.

Accordingly, the length x=Ld/2 of the first polarization region 6a in a downstream part in the optical propagation direction in the interference optical waveguide 3b-2 is substantially a half of the length y=Ld of each propagation region 6a, 6b formed in an upper stream part in the light propagation direction than the first polarization region 6a.

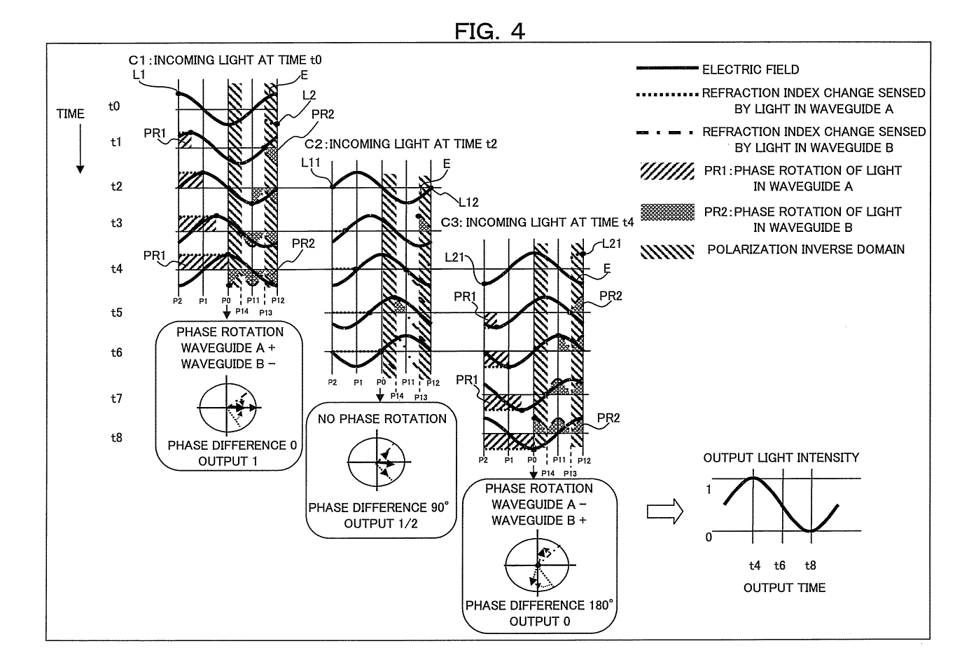

In this instance, it is possible to suppress a waveform distortion of the modulated light output from the output optical waveguide 3c by means of making the total sum of the lengths of the first polarization regions 6a and the second propagation regions 6b alternately arranged in the interference optical waveguide 3b-2 equal with respect to each other. That is, in a case where the length of the second electrode unit 41b in the interference optical waveguide 3b-2 is Lb, the total sum of the lengths passing through the first polarization region 6a is made to be Lb/2, and likewise, the total sum of the lengths passing through the second propagation inverted region 6b is made to be Lb/2. As illustrated in FIG. 4, this makes the output light level equivalent to ½ in the case where the input voltage is ½, so that the waveform distortion is reduced.

According to the first embodiment, it is possible to make the total sum of the lengths of the first polarization regions 6a to be Lb/2 by means of forming the first polarization region 6a-n (n is a numerical number not smaller than “2”; in this case, n is a numerical number not smaller than “3”) at the most downstream position of the electric signal propagating through the second electrode unit 41b.

In the optical waveguide device 1 according to the first embodiment with the above construction, an electric signal proceeding through the interference optical waveguide 3b-1 in the light propagation direction with the electrode 41, and an electric signal proceeding through the interference optical waveguide 3b-2 in the light propagation direction opposite to the light propagation direction from the downstream light propagation direction, thereby changing the refraction index of the interference optical waveguides 3b-1 and 3b-2. At that time, since the periodical propagation characteristics region 6 makes it possible to give the interference optical waveguide 3b-l the inversed electric field opposite to that given to the interference optical waveguide 3b-2, as a whole, even with consideration paid to the phase change of the applied electric signal. This improves the efficiency (modulation efficiency) of the phase change.

As illustrated in FIG. 4, for example, at time series from time t0 through time t8, light components (L1 and L2) propagate through the interference optical waveguides 3b-1 and 3b-2, respectively, and an electric signal (E) propagates in the upper part of the interference optical waveguides 3b-1 and 3b-2 through the electrode 41.

First of all, as illustrated in C1 (times t0 through t4) of FIG. 4, an attention is paid to the light components (points L1 and L2), which pass through the points P2 and P12 that are apart from the horizontal axis coordinate P0 by a half wavelength distance of the electric signal in the first and second electrode units 41a and 41b, at the time t0, and then combined with one another in the output optical waveguide 3c (see FIG. 1).

In this case, partly since the applied electric signal level at the time the light L2 passes through the first polarization region 6a in the interference optical waveguide 3b-2 is positive, and partly since the electric signal level at the time the light L2 passes through the second propagation region 6b is negative, a negative direction electric field is applied to the component propagating through the interference optical waveguide 3b-2 regardless of the propagation positions, so that the phase change amount PR2 is in the negative direction.

In contrast to this, since the first electrode unit 41a formed in the upper part of the interference optical waveguide 3b-1 makes a proceeding electric wave electrode, the component L1 propagating through the interference optical waveguide 3b-1 is given a positive-direction (the direction opposite, in polarization, to the one propagating through the interference optical waveguide 3b-2) electric field is applied regardless of the propagation positions, so that the phase change amount PR1 is also a positive direction (see times t0 through t4 in C1 of FIG. 4). This makes it possible to rotate the phases of the propagation light in the directions opposite with respect to one another at the time point (see time t4) at which the propagation light is output in the output optical waveguide 3c as an output of “1”.

Subsequently, as illustrated in C2 (times t2 through t6) of FIG. 4, an attention is paid to the light components (positions L11 and L12) which pass through the above mentioned points P2 and P12 at the time t2 and then combined together in the output optical waveguide 3c (see FIG. 1). In this case, the direction of the electric field at the time the light L12 passes through the first polarization region 6a whose starting point is the coordinate P12 in the interference optical waveguide 3b-2. Further, the electric signal level when passing through the second propagation region 6b whose starting point is the coordinate P13, is both in the regions of a negative direction and a positive direction. The polarization in the phase rotation direction given before and after passing through the second propagation region 6b whose starting point is the coordinate P11, which is the intermediate position, is inversed.

At that time, the cumulative total value of the amounts of the phase change given at the time light propagates from the coordinate P13 to the coordinate P11 is such a value as that which is substantially equivalent to that of the amount of phases given at the time the light passes through the second propagation region 6b from the coordinate P12 to the coordinate P13 in their absolute values, and which is different in polarization. Likewise, the cumulative total value of the phase change amounts of the phase change given at the time light propagates from the coordinate P1 to the coordinate P14 is such a value as that which is substantially equivalent to that of the amount of phases given at the time the light passes through the second propagation region 6b in their absolute values, and which is different in polarization. In this manner, since the phase change amounts at adjacent propagation positions are balanced out therebetween, the phase change amount as a whole becomes “0”.

In contrast to this, since the first electrode unit 41a formed in the upper part of the interference optical waveguide 3b-1 constructs the proceeding electric wave electrodes, the component L11 propagating through the interference optical waveguide 3b-1 is applied with the electric field (0) corresponding to a phase change amount of “0” (equivalent to that which propagates through the interference optical waveguide 3b-2) regardless of the propagation positions (see times t2 through t6 in C2 in FIG. 4). With this arrangement, the phase of the propagation light does not change at the time point (see the time t6) at which an output is performed in the output optical waveguide 3c, and the output can be made to be “½”.

Then, as illustrate in C3 (times t4 through t8) of FIG. 4, an attention is paid to the light components (positions L21 and L22) which pass through the above mentioned points P2 and P12 at the time t4 and then combined together in the output optical waveguide 3c (see FIG. 1). In this case, the applied electric signal level at the time the light L2 passes through the first propagation region 6a in the interference optical waveguide 3b-2 is negative, and the electric signal level at the time the light L2 passes through the second propagation region 6b is positive, so that a positive-direction electric field is applied to the component propagating through the second propagation region 6b. As a result, a positive-direction electric field is applied to the component passing through the interference optical waveguide 3b-2 regardless of propagation positions, and the phase variation amount PR2 is in a positive direction.

In contrast to this, since the first electrode unit 41a formed in the upper part of the interference optical waveguide 3b-1 constructs a proceeding wave electrode, the component L21 propagating through the interference optical waveguide 3b-1 is applied with a negative-direction electric field in the negative direction (the direction of the polarization is opposite to the one which propagates through the interference optical waveguide 3b-2) regardless of the propagation positions. With this arrangement, the phases of the propagation light are rotated in the opposite directions with respect to each other at the time point (see the time t4) at which output is performed in the output optical waveguide 3c, so that an output of “0” can be realized. Accordingly, the light output from the present optical waveguide device 1 can be modulated into a light signal whose output light level cyclically varies between “1” and “0”.

Further, in the above described first embodiment, such a construction is given that the first polarization regions 6a and the second propagation regions 6b, as the periodical propagation inversion region 6, are alternately arranged over the region of the substrate 2 in which the interference optical waveguide 3b-2 is formed. In addition, such a construction is given that the length of the first polarization region 6a in the most upstream part in the light propagation direction in the interference optical waveguide 3b-2 is substantially a half of that of each polarization region 6a, 6b formed at the upper stream parts than these polarization regions in the light propagation direction. Yet further, the region corresponding to that, which is from the coordinate P12 to the coordinate P0 shown in FIG. 4, can be regarded as the unit of the periodical cyclic pattern.

That is, as the periodical propagation inversion region 6, the unit of the cyclic pattern is constructed by the second polarization region 6b and the first polarization region 6a that has a length of a substantial half of the length of the second propagation region 6b in the upstream and the downstream light propagation direction in the second propagation region 6b, so that it is possible to arrange these cyclic patterns in the substrate region along the optical propagation direction, which includes the interference optical waveguide 3b-2. With this arrangement, the sum of the lengths of polarization inversion regions, each for a polarization characteristic, can be made to be the above mentioned Lb/2, so that the distortion of the waveform can be reduced.

In this manner, the optical waveguide device 1 according to the first embodiment has a cyclic propagation characteristic region 6, different from the case illustrated in FIG. 16 having the signal electrode 101 and the ground electrodes 104, and thus, the electric signal applied to the signal electrode 41 can be propagated in the upper parts of the two interference optical waveguides 3b-1 and 3b-2 while the electric fields given to the light at the corresponding propagation positions are made to be opposite with respect to one another. As a result, it is possible to positively form an electric field with an electric line of force from the electrodes 41 (41a, 41b) which are formed in the upper part of both of the two interference optical waveguides 3b-1 and 3b-2, so that the efficiency of the phase change can be improved, as a whole, in comparison with the case illustrated in FIG. 17.

In this instance, according to the above described first embodiment, the lengths of the first and second polarization regions 6a and 6b are derived with no attention paid to the propagation distance in the third electrode unit 41c and the phase change of the electric signal corresponding to the propagation distance. In a case where it cannot be said that the propagation wavelength λ and the above mentioned wavelength λm are not sufficiently longer than the length (or a distance between the interference optical waveguides 3b-1 and 3b-2) Li of the third electrode unit 41c, delay in this third electrode unit 41c can cause lowering of the modulation efficiency. In such a case, it is possible to improve the modulation efficiency by means of making the length of the first polarization region 6a through which the electric signal initially passes in the interference optical waveguide 3b-2 to be VoVm/(4(Vm+Vo)f−Li. This makes it possible to improve the modulation efficiency.

### [b] Second Embodiment

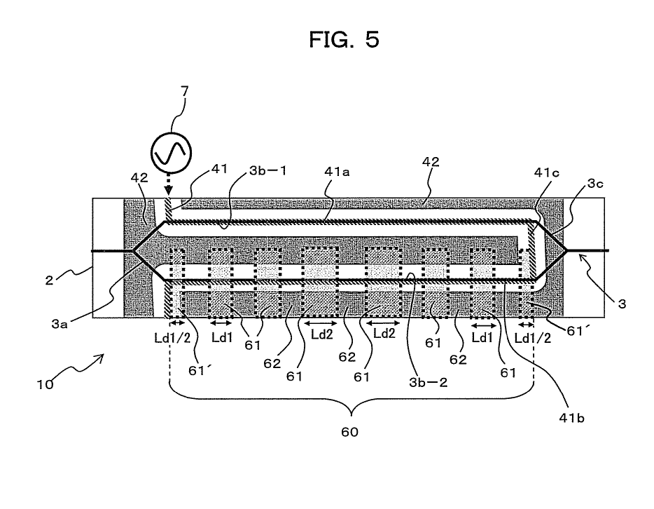

FIG. 5 is a diagram, viewed from the top, illustrating an optical waveguide device 10 according to a second embodiment of the present invention. The optical waveguide device 10 depicted in FIG. 5 differs from the one that is already described in the first embodiment in construction of the periodical polarization characteristic region 60, and the construction other than the above is basically similar to that which is already described. In this instance, the reference characters in FIG. 5 similar to those which are already described with reference to FIG. 1 indicate approximately the same part therebetween.

That is, in the optical waveguide device 10 according to the second embodiment, similar to the case of the first embodiment, such a construction can be given as an RZ light pulse modulator, which generates an RZ light pulse having a frequency equivalent to that which is applied to the electrode 41 by modulation performed to the input light, for example, or the frequency equivalent to a two-fold electric signal frequency. Further, an intensity modulator, which performs intensity modulation to a data signal, can be further coupled to the RZ light pulse modulator with such a construction.

Here, the periodical propagation characteristics region 60 also has a construction in which the first polarization regions 61 and 61′ and the second polarization regions 62 having the second polarization characteristic with the polarization characteristic opposite to that of the first polarization regions 61 and 61′ are alternately arranged over the region of the LN substrate 2 on which the interference optical waveguide 3b-2 is formed. However, the lengths of each first polarization characteristic 61, 62 and each second polarization region 62, differ from those (see reference codes 6a and 6b) which are already described in the first embodiment.

That is, when such a construction as that an electric signal at a frequency of f, as an electric signal, is applied to the electrode 41, assuming that the velocity of the light propagating through the interference optical waveguide 3b-2 is Vo, and also that the velocity of the electric signal proceeding in the upper part of the interference optical waveguide 3b-2 in the signal electrode 41 is Vm, the periodical propagation characteristics region 60 has the first polarization region 61′ whose substantial length is VoVm/(4 (Vm+Vo)(f+df))=(Ld1)/2 at the most downstream light propagation direction part and the most upstream light propagation direction part, based on the supposed frequency change df of an electronic signal applied to the signal electrode 41, and the lengths of the first and second propagation regions 61 and 62 arranged between these first polarization regions 61a periodically change in accordance with the arrangement positions thereof.

More precisely, the first and second propagation regions 61 and 62 arranged between the first polarization regions 61′ in the upstream light propagation direction and the downstream light propagation direction are constructed such that those are distributed between Ld1=VoVm/(2(Vm+Vo)(f+df) and Ld2=VoVm/(2(Vm+Vo)(f −df)) based on the supposed frequency change df of an electronic signal supplied as an electric signal.

For example, the original data to be modulated as a light signal increases and decreases in bit rate due to an error correction code added to a practical data series with the error correction scheme. Thus, by using the formula for deviating “y” in the first embodiment, the lengths of the first and second propagation regions 61 and 62 are decided. In other words, “df” is made to be a frequency equivalent to increase in bit rate due to the error correction code added to the data signal, which is the original data to be modulated as a light signal.

In this case, such a construction is given as that the lengths of the first and second propagation regions 61 and 62 become shorter sequentially from the above mentioned Ld2 to Ld1, and the first and second polarization regions 61 and 62, whose lengths are symmetrical with respect to the intermediate position of the interference optical waveguide 3b-2, are distributed and arranged.

In other words, due to the first polarization regions 61 and 61′ and the second polarization region 62, the periodical propagation characteristics region 60 is constructed in such a manner that the distribution of the lengths of the polarization regions 61, 61′, and 62 is symmetrical with respect to the intermediate position of the interference optical waveguide 3b-2.

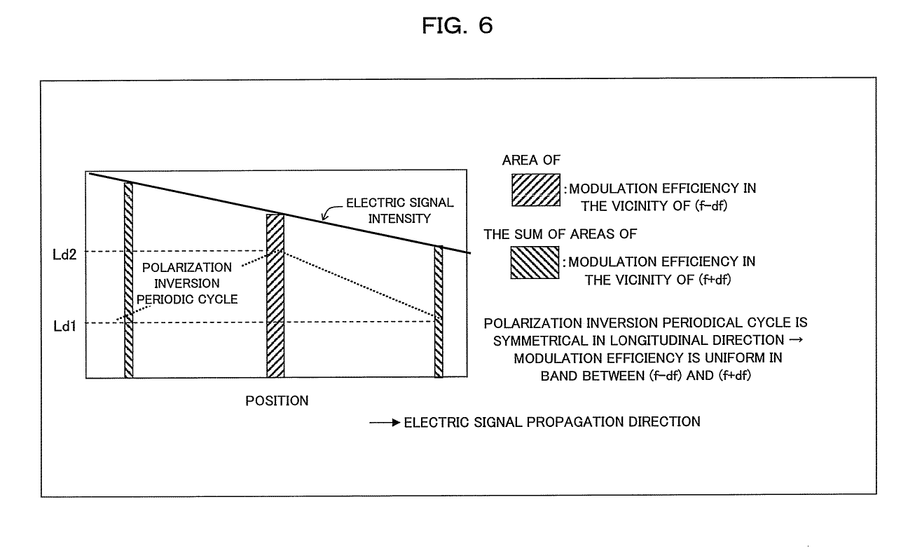

As illustrated in FIG. 6, the electric signal applied to the electrode 41 attenuates as propagation proceeds, so that even the electric field intensity given to the interference optical waveguide 3b-2 by the electric signal propagating in the second electrode unit 41b changes as the propagation proceeds. Then, the light modulation efficiency is equivalent to the area of the refraction index change corresponding to the electric field intensity (and propagation characteristics) at the position of the periodical propagation characteristics region 60. In other words, the light modulation efficiency lowers as the propagation of the electric signal proceeds.

Thus, the lengths of the first and second polarization regions 61 and 62 are made to be large (Ld2) at the intermediate position in the interference optical waveguide 3b-2, and also made to be smaller as the distance from the intermediate position becomes larger in the upstream light propagation direction and in the downstream light propagation direction (Ld1→(Ld1)/2), and the ones whose lengths are symmetrical with respect to the intermediate position are distributed and arranged. This makes it possible to uniform the modulation efficiency in the interference optical waveguide 3b-2 from the upstream side in the light propagation direction to the intermediate position and the modulation efficiency therein from the intermediate position to the downstream side in the light propagation direction, even if the propagation attenuation of the electric signal occurs.

With this arrangement, in the optical waveguide device 10 according to the second embodiment, the advantages similar to the case in the already described first embodiment are realized. In addition, since the first and second polarization regions 61 and 62 are made to have widths that take the frequency change of the electric signal applied to the electrode 41 into consideration, the unevenness of the modulation efficiency characteristic due to the frequency change, such as the error correction scheme of the original data to be modulated as a light signal, is planarized, the modulation characteristic as that of an optical modulator can be improved.

Further, since the periodical propagation characteristics region 60 is constructed in such a manner that the distribution of the lengths of the first and second polarization regions 61, 61′ and 62 is symmetrical with respect to the intermediate position in the interference optical waveguide 3b-2 in the light propagation direction, it is possible to uniform the modulation efficiency in the interference optical waveguide 3b-2, from the upstream side to the intermediate position, and the modulation efficiency in the interference optical waveguide 3b-2, from the intermediate position to the downstream side in the light propagation direction, even if propagation attenuation of the electric signal occurs.

### [c] Third Embodiment

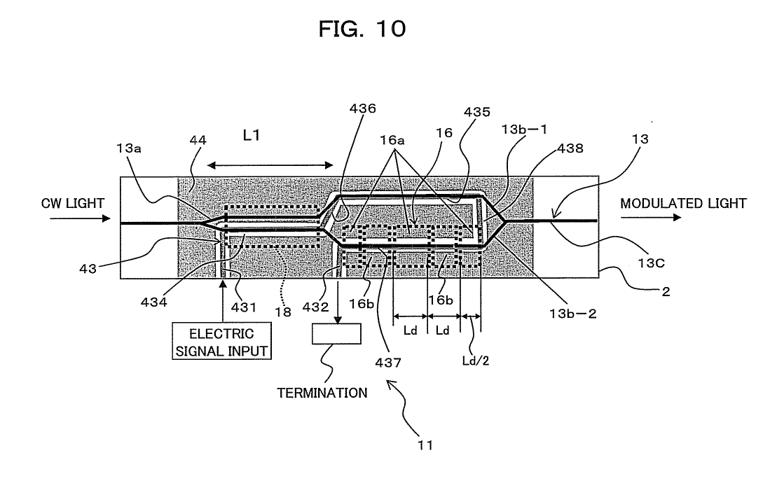

FIG. 10 is a diagram, viewed from the top, illustrating an optical waveguide device 11 according to a third embodiment of the present invention. Similar to the case of the first embodiment, such a construction can be given as an RZ light pulse modulator, which generates an RZ light pulse having the frequency equivalent to that which is applied to the electrode 41 by modulation performed to the input light, for example, or the frequency equivalent to a two-fold electric signal frequency. Further, an intensity modulator, which performs intensity modulation to a data signal, can be further coupled to the RZ light pulse modulator with such a construction.

Further, the optical waveguide device 11 according to the third embodiment includes a Mach-Zehnder optical modulator 13, which has a shape different from that of the optical waveguide device 1 (see FIG. 1) according to the already described first embodiment, the signal electrode 43, and the ground electrodes 44. Yet further, the pattern of the polarization inversion region formed on the substrate 2 differs from that which is formed in the first embodiment.

Here, the Mach-Zehnder optical modulator 13 includes the input waveguide 13a, the interference optical waveguides 13b-l and 13b-2, and the output optical waveguide 13c. The upstream part of the interference optical waveguides 13b-1 and 13b-2, which are coupled to the input waveguide 13a, has a narrow distance between the waveguides in comparison with the downstream part in the interference optical waveguides 13b-1 and 13b-2 in the light propagation direction.

Further, similar to the one (see reference character 41) which is already described with reference to FIG. 1, the electrode 43 is formed in such an integrated and connected manner that an electric signal applied thereto travels from the upper part of either one of the optical waveguides 13b-1 and 13b-2 to the upper part of the other one. The signal electrode 43 differs from the one that is illustrated in FIG. 1 in that it includes the fourth to eighth electrode units 434 through 438.

The fourth electrode unit 434 makes an electric signal from the electric signal input terminal 431 proceed in the first direction of an upper part in the interference optical waveguide 13b-2, and the fourth electrode unit 434 is formed in part of the upper side of the light propagation direction in the interference optical waveguide 13b-2. Further, the fifth electrode unit 435, formed in the upper part in the interference optical waveguide 13b-1, makes the above mentioned electric signal proceed in the first direction, which is the same as the direction in the fourth electrode unit 434, and the fifth electrode unit 435 is formed in part of the downstream side of the light propagation direction in the interference optical waveguide 13b-1. Yet further, the sixth electrode unit 436 couples the downstream position in the direction of an electric signal forming the fourth electrode unit 434 to the upstream position in the direction in which an electric signal proceeds in the fifth electrode unit 435. With this arrangement, an electric signal proceeding in the fourth electrode unit 434 travels in the fifth electrode unit 435 by way of the sixth electrode unit 436.

Further, the seventh electrode unit 437, formed at a position, which is apart from the position at which the fourth electrode unit 434 is formed, in the upper part of the interference optical waveguide 13b-2 which makes the above mentioned electric signal proceed in the second direction opposite to the first direction, and the seventh electrode unit 437 is formed in part of a downstream side of the light propagation direction in the interference optical waveguide 13b-2. Yet further, the eighth electrode unit 438 couples the downstream position in the electric signal proceeding direction, which downstream position forms the sixth electrode unit 436, to the upstream position in the electric signal proceeding direction. With this arrangement, the electric signal proceeding in the sixth electrode unit 436 proceeds in the eighth electrode unit 438 by way of the seventh electrode unit 437.

In this instance, the electric signal which proceeds in the seventh electrode unit 437 is output through the output terminal 432, and is then coupled to the ground electrodes 44 by way of a resistor (not illustrated). Further, the ground electrodes 44, for example, are uniformly arranged in such a manner that they enclose the region, in which the signal electrode 43 is formed on the surface of the substrate 2, at specific intervals.

Further, the region of the substrate 2, in which the fourth electrode unit 434 and the fifth electrode unit 435 are formed, are formed as a filed having the polarization characteristics opposite with respect to each other. In the case illustrated in FIG. 10, the polarization-inversed region 18 in which the polarization characteristic of the substrate 2 is inversed. On the other hand, in the field of the substrate 2, in which the fifth electrode unit 435 is formed, a substrate region whose polarization characteristic is not inversed is constructed.

Yet further, in the field of the substrate 2 including the region in which the seventh electrode 437 is formed, the periodical polarization characteristic region 16 corresponding to the one which is already described according to the first embodiment (see reference character 6) is formed. The periodical polarization characteristic region 16 has a construction, in which the first polarization region 16a having the polarization characteristic opposite to that which the substrate 2 has and the second polarization region 16b having the second polarization characteristic opposite to the first polarization characteristic, are alternately arranged over the region in which the seventh electrode unit 437 is formed, which region is the region of the substrate 2 in which the interference optical waveguide 13b-2 is formed. In this instance, in correspondence to the first electrode units 6a-1 and 6a-n according to the above described first embodiment, the first polarization region 16a substantially having a length of Ld/2 is formed in the electric signal most upstream position and the electric signal most downstream position in the seventh electrode unit 437, and the first and second polarization regions 16a and 16b substantially having a length of Ld are alternately formed.

In the optical waveguide device 11 with the above described construction, the electric signal applied to the signal electrode 43 travels through the interference optical waveguide 13b-2 in the same direction as that in which light travels in the fourth electrode unit 434, and then travels through the interference optical waveguide 13b-2 in the same direction as that in which light travels in the fifth electrode unit 435 by way of the sixth electrode unit 436. After that, the electric signal travels through the interference optical waveguide 13b-2 in the opposite direction to that in which light travels in the seventh electrode 437 by way of the eighth electrode unit 438.

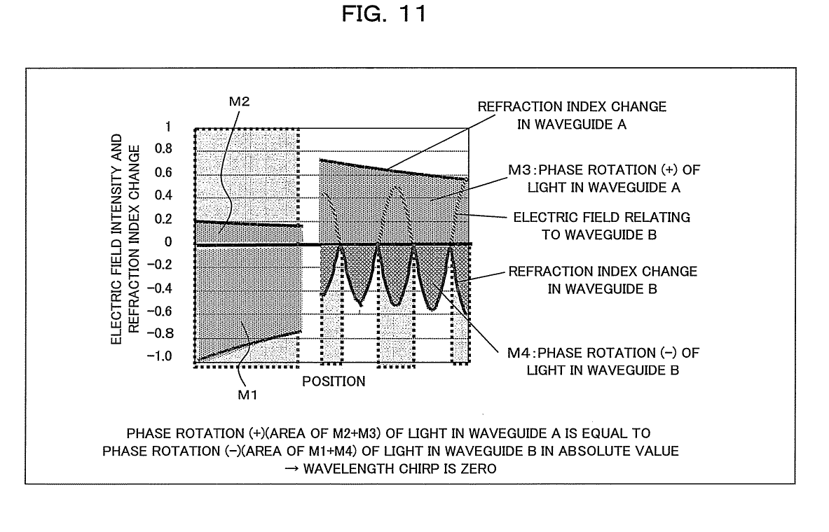

At that time, the part of the signal electrode 43 in the interference optical waveguide 13b-2, in which part light proceeds in the same direction as that in which light proceeds, is inversed in polarization, and the part in which the light proceeds in the direction opposite to the light proceeding direction. FIG. 11 is a diagram that illustrates the electric field directions (phase rotation direction) given to the light proceeding through the two interference optical waveguides 13b-1 and 13b-2 by the electric signal proceeding in the signal electrode 43 having the above described shape.

Here, in FIG. 11, the reference character M1 indicates the phase change amount of light caused in the region in which the fourth electrode unit 434 is formed in the interference optical waveguide 13b-2; the reference character M2 indicates the phase change amount of light given by the region whose direction of the electric field is opposite to that of the electric field given by the fourth electrode unit 434 in the interference optical waveguide 13b-1. Further, the reference character M3 indicates the phase change amount of light caused in the region in which the fifth electrode unit 435 is formed in the interference optical waveguide (waveguide A) 13b-1; the reference character M4 indicates the phase change amount of light caused in the region of the seventh electrode 437 in the interference optical waveguide (waveguide B) 13b-2.

As illustrated in FIG. 11, the phase change amount of the light generated in the fourth and fifth electrode units 434, 435 in the regions of the fourth and fifth electrode units 434 and 435 is opposite with respect to each other in direction due to inversion of the polarization characteristic. Thus, it is possible to make the light phase change amount (equivalent to the sum of the areas M1 and M4) that is given to the interference optical waveguide 13b-1 and the light phase change amount (equivalent to the sum of the areas M2 and M3) that is given to the interference optical waveguide 13b-1 opposite in direction thereof and substantially equal in the largeness thereof.

In other words, in the optical waveguide device 11 according to the third embodiment, it is possible to reduce a difference in largeness of the electric fields, whose directions are opposite to each other, given to the two interference optical waveguides 13b-1 and 13b-2, in comparison with the case of the optical waveguide device 1 according to the first embodiment. As a result, it is possible to suppress the wavelength chirp of the modulated light output from the output optical waveguide 13c.

In particular, the lengths of the fourth electrode unit 434, the fifth electrode unit 435, and the seventh electrode 437, are set in such manner that the phase change amount of the light propagating through the interference optical waveguide 13b-1 and the light phase change amount of the light propagating through the interference optical waveguide 13b-2 differ from each other in polarization thereof and becomes substantially equal to each other in absolute value thereof. This makes it possible to approximately suppress the above mentioned wavelength chirp.

In this instance, partly since the fourth electrode unit 434 is formed along the interference optical waveguide 13b-2 at its upstream side in the light propagation direction whose distance is relatively small between the two interference optical waveguide 13b-1 and 13b-2, and partly since the fifth and seventh electrode units 435 and 437 are formed along the interference optical waveguides 13b-1 and 13b-2 at their downstream sides, respectively, in the light propagation direction whose distance is relatively large between the two interference optical waveguides 13b-1 and 13b-2, it is possible to approximately suppress the above mentioned wavelength chirp by manes of adjusting the length L1s of the interference optical waveguides 13b-1 and 13b-2 in the upstream side in the light propagation direction, the distance therebetween is made to be substantially relatively small.

Here, at the position (flow area) at which the fourth electrode unit 434 constitutes the signal electrode 43 proceeds in the same direction as that in which light proceeds in the interference optical waveguide 13b-2, the electric field generated by the ground electrodes 44 is applied to the interference optical waveguide 13b-1.

In the optical waveguide device 11 according to the third embodiment, the two interference optical waveguides 13b-1 and 13b-2 are constructed in such a manner that the distance between the two interference optical waveguides 13b-1 and 13b-2 at the position (flow area) at which the fourth electrode unit 434 is formed, is smaller than that between the interference optical waveguides 13b-1 and 13b-2 at the position (follow area) at which the seventh electrode 437 is formed in the upper part of the interference optical waveguide 13b-2.

As a result, since the interference optical waveguide 13b-2 at the position at which the fourth electrode unit 434 is formed can be closed to the interference optical waveguide 13b-2 in the range in which no effect from interference by the propagation light, the direction of the electric field given to the interference optical waveguide 13b-1 can be close to in the direction opposite to that of the electric field given to the interference optical waveguide 13b-2 in the lower part of the fourth electrode unit 434. This contributes to improvement in modulation efficiency.

In this manner, the optical waveguide device 11 according to the third embodiment makes it possible for the first embodiment to realize the advantages similar to those that are realized in the one according to the first embodiment. Further, since the optical waveguide device 11 has the fourth through eighth electrode units 434 through 438, it is possible to reduce a difference of the size of the electric field in the opposite direction, which electric field is given to the two interference optical waveguides 13b-1 and 13b-2. Therefore, such an advantage is brought about that the wavelength chirp of the modulated light output from the output optical waveguide 13c can be suppressed.

### [c1] Modified Examples of the Third Embodiment

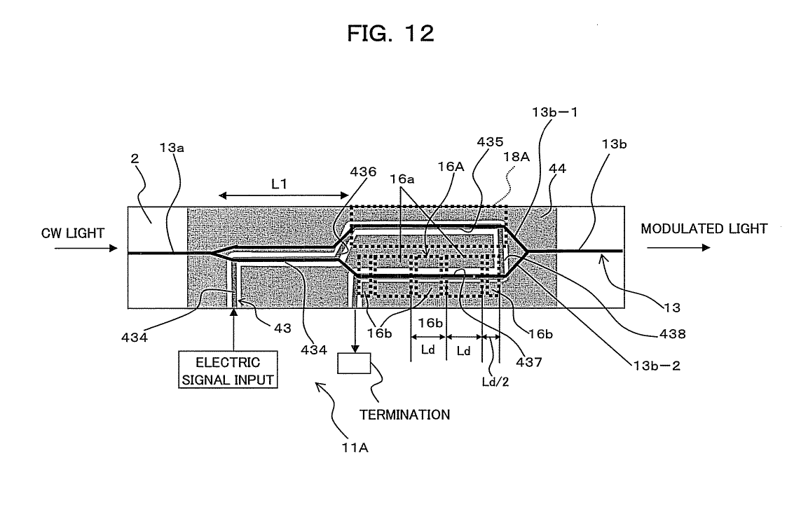

FIG. 12 is a diagram, viewed from the top, illustrating a modified example of the optical waveguide device 11A according to the third embodiment. The optical waveguide device 11A illustrated in FIG. 12 is similar to that which is illustrated in FIG. 10 in that the device 11A includes: the Mach-Zehnder output optical waveguide 13; the signal electrode 43; and the ground electrodes 44, similar to those which are illustrated in FIG. 10. However, the optical waveguide device 11A differs from that which is illustrated in FIG. 10 in that the distribution of the polarization characteristics in the substrate region in which the fourth, fifth, seventh electrode units 434, 435, and 437, is inversed with respect to that illustrated in FIG. 10.

That is, the region of the substrate 2 containing the region on which the fourth electrode unit 434 is formed, is constructed as a substrate region in which propagation characteristic is not inversed; the region of the substrate 2 in which the fifth electrode unit 435 is formed, has the polarization-inversed region 18A formed therein. Further, the periodical polarization characteristic region 16A formed in the field of the substrate 2 in which the seventh electrode 437 is formed, has a construction such that the arrangement of the first polarization regions 16a and the second polarization regions 16b is the inverse of that which is in a case of the first polarization region 16a illustrated in FIG. 10. In this case, at the most upstream electric signal position and the most downstream electric signal position, the second polarization regions 16b having a substantial length of Ld/2 are formed, while the first and second polarization regions 16a and 16b having a substantial length of Ld are alternately formed in the intermediate part.

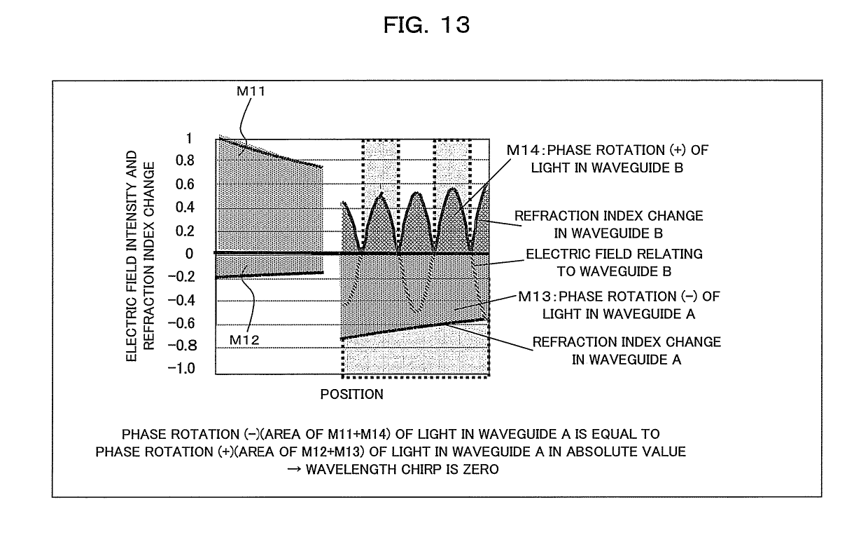

As illustrated in FIG. 13, in the optical waveguide device 11A, electric field intensity is given to the two interference optical waveguides 13b-1 and 13b-2 with the profile opposite to that of the case FIG. 11. Here, in FIG. 13, the reference character M11 indicates the phase change amount of light generated in the region of the interference optical waveguide 13b-2 in which the fourth electrode unit 434 is formed, and the reference character M12 indicates the phase change amount of light, which is given from the electric field whose direction is opposite to that generated in the region of the interference optical waveguide 13b-1 in which the fourth electrode unit 434 is formed. Further, the reference character M13 indicates the phase change amount of light generated in the region of the interference optical waveguide (waveguide A) 13b-1 in which the fifth electrode unit 435 is formed; the reference character M14 indicates the phase change amount of light generated in the region of the interference optical waveguide (waveguide B) 13b-2 in which the seventh electrode unit 437 is formed.

As illustrated in FIG. 13, the phase change amount of the light generated in the regions in which the fourth and fifth electrode units 434 and 435 are made to be opposite to each other in direction by means of inversion of the polarization characteristics. Thus, it is possible to make the phase amount (equivalent to the sum of the areas of M11 and M14) of the light given to the interference optical waveguide 13b-1 substantially equal to the phase amount (equivalent to the sum of the areas of M12 and M13) of the light given to the interference optical waveguide 13b-1 in direction and different from each other in size.

Accordingly, in the optical waveguide device 11A illustrated in FIG. 12, also, the fourth through eighth electrodes 434 through 438 realize the advantages similar to those described in the third embodiment.

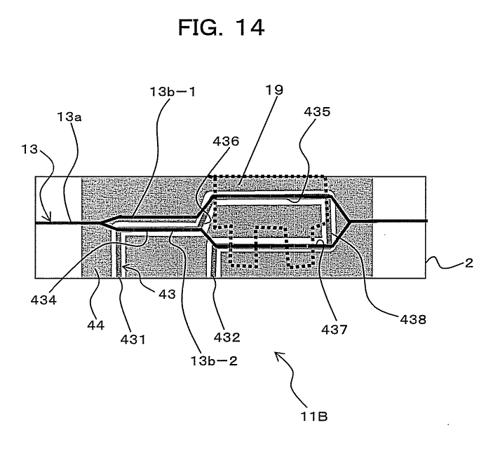

Further, as a second modified example of the third embodiment, the optical waveguide device 11B with the construction illustrated in FIG. 14 can be given. The optical waveguide device 11B illustrated in FIG. 14 has the polarization inversed region 19 formed as an integrated region, in which the polarization-inversed region 18A and the second polarization region 16b whose polarization characteristic is similar to that of the polarization-inversed region 18A. This realizes not only the advantages similar to those according to the above described third embodiment but also an advantage such that the polarization inversed region containing the interference optical waveguide 13b-1 and the polarization inversed region containing the interference optical waveguide 13b-2 are combined together, the boundary line being thereby reduced in comparison with that illustrated in FIG. 12. As a result, the manufacturability of the optical waveguide device 11B can be improved.

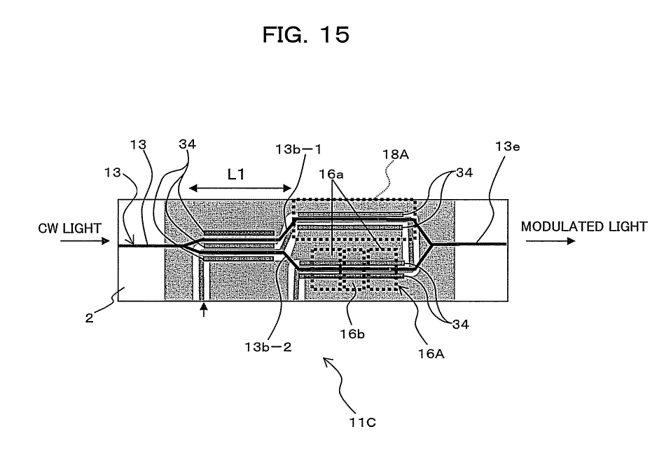

Yet further, as a third modified example of the third embodiment, the optical waveguide device 11C with the construction illustrated in FIG. 15 can be given. The construction of the optical waveguide device 11C illustrated in FIG. 15 differs from that illustrated in FIG. 14 in that the grooves 34 are formed on both of the sides of the interference optical waveguides 13b-1 and 13b-2. With such an arrangement, each of the interference optical waveguides 13b-1 and 13b-2 is constructed as a ridge waveguide.

Here, the signal electrode 43 has a construction in which the interference optical waveguide 13b-1 and the interference optical waveguide 13b-2 are laid across by the sixth and eighth electrode units 436 and 438. With this arrangement, a construction in which the grooves 34 are divided at the position in the intermediate flow region. Therefore, the necessity for the grooves 34 to be formed across the sixth electrode unit 436 is eliminated, so that it is possible to prevent an occurrence of breaking of wire.

### [d] Others

Further, the present invention should by no means be limited to the above-illustrated embodiments, and various changes or modifications may be suggested without departing from the gist of the invention.

For example, according to the second embodiment, the lengths of the first and second polarization regions 61, 61′, and 62 constituting the periodical propagation characteristic region 60 are constructed in such a manner that the lengths cyclically change according to their positions for making the variation of the modulation efficiency uniform due to propagation of an electric signal. According to the present invention, a construction such that the present invention has the construction of the periodical propagation inversion region 6 according to the first embodiment and also such that the propagation velocity of the electric signal propagating in the second electrode unit 41b changes in accordance with the propagation positions (about the light propagation direction of the interference optical waveguide 3b-2), makes it possible to realize the advantages similar to those described in the second embodiment.

In this case, when the cyclical period (see, for example, reference character 6 in FIG. 1) of the polarization characteristic is given as Ldi, the optical waveguide device is constructed in such a manner that the velocity of the electric signal changes between 2Ldi(f+df)Vo/(Vo−2Ldi(f+df)) and 2Ldi(f−df)Vo/(Vo−2Ldi(f−df)) based on the frequency change df.

More precisely, the following construction is also capable of realizing the velocity change according to the propagation position of the electric signal, as described above: the second electrode unit 41b formed in the upper part of the interference optical waveguide 3b-2 changes the distance between the second electrode unit 41b and the ground electrodes 42, which encloses the second electrode unit 41b at specific intervals; the second electrode unit 41b formed in an upper part of the interference optical waveguide 3b-2 changes in thickness in accordance with the propagation direction; the second electrode unit 41b changes in width according to the propagation direction. With the above described construction, the velocity changes in accordance with the propagation position of the above described electric signal as described above.

The following construction is also available: a buffer layer is interposed between the substrate 2 and the electrode 41 and also the thickness of the buffer layer between the interference optical waveguide 3b-2 and the electrode 41 changes in the light propagation direction in the electrode 41. Further, in the construction illustrated in FIG. 5 according to the second embodiment, the grooves are formed on both sides of the interference optical waveguide 3b-1 on the substrate 2 in such manner that the width of this ridge waveguide changes in the light propagation direction. That is, it is possible to realize the velocity change in accordance with the above mentioned propagation positions of the electric signal.

At that time, if the propagation velocity of the electric signal is changed, as is described above, it can make the characteristic impedance changed, appropriate combinations of the above described constructions are capable of making the characteristic impedance constant in light propagation direction in the interference optical waveguide 3b-2.

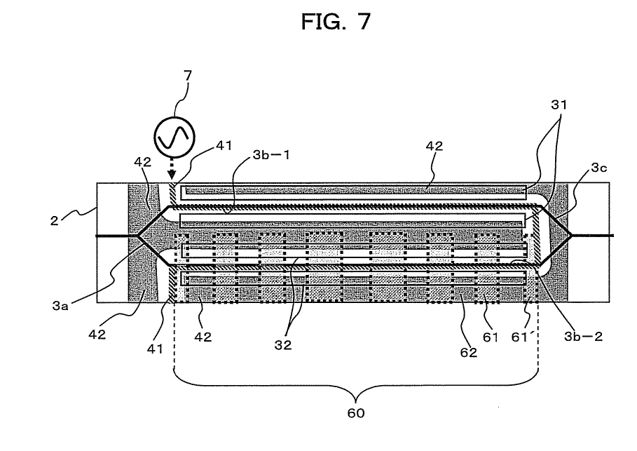

Further, the interference optical waveguides 3b-1 and 3b-2 can be constructed as ridge waveguides. As illustrated in FIG. 7, for example, the interference optical waveguides 3b-1 and 3b-2 can be constructed as ridge waveguides by means of forming the grooves 31 and 32 on both sides of the interference optical waveguides 3b-1 and 3b-2. That is, when the grooves 31 are formed at both sides of the interference optical waveguide 3b-1 formed in the upper part of the first electrode unit 41a, the ridge-construction waveguide being thereby realized, and a loss of light can be caused by roughness of the side surfaces of the grooves 31. Thus, the grooves 32 can be formed at both sides of the other interference optical waveguide 3b-2, the loss in the two interference optical waveguides 3b-1 and 3b-2 being thereby constant, so that the deterioration of the extinction ratio is suppressed.

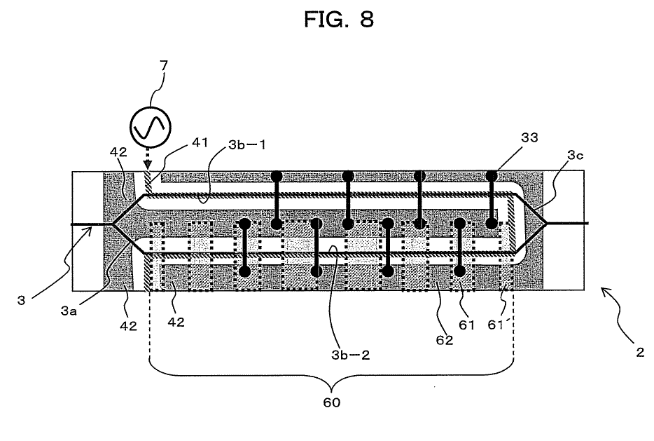

Yet further, as illustrated in FIG. 8, to make the distance between the two interference optical waveguides 3b-1 and 3b-2 larger three times or more the distance between the electrode 41 and the ground electrodes 42, is capable of suppressing the interference of the light which proceeds through the interference optical waveguides 3b-1 and 3b-2, so that the deterioration of the modulation efficiency is suppressed. In addition, in this case also, the absolute distance itself between the interference optical waveguides 3b-1 and 3b-2 is made to be short as much as possible for making the delay of the electric signal due to the third electrode unit 41c ignorable. Thus, it is considerable that the width of the ground electrodes 42 between the interference optical waveguides 3b-1 and 3b-2 is relatively narrowed. In this manner, it is considerable that the loss of the electric signal increases with no ground effect due to the ground electrodes 42 enough to narrow the width of the ground electrodes 42, the loss of the electric signal being thereby increased. Thus, for securing the grounding effects of the ground electrodes 42, it is possible to couple the regions of the ground electrodes 42 sandwiched between the two interference optical waveguides 3b-1 and 3b-2 to the regions of the ground electrodes 42 formed outside the interference optical waveguides 3b-1 and 3b-2 by way of the bonding wire 33. With this construction, it is possible to suppress the loss of the electric signal.

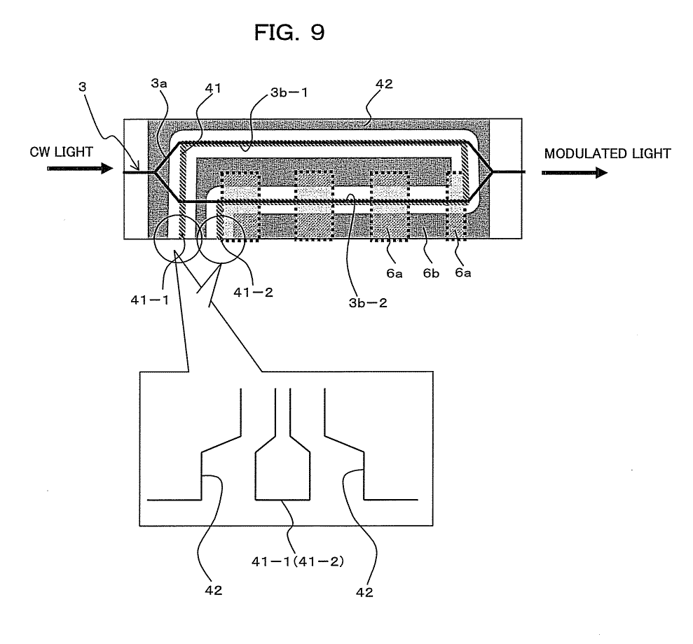

Still further, as illustrated in FIG. 9, the electrode pad 41-1, which forms the electric signal input terminal coupled to the clock signal source 7 in the electrode 41, and the electrode pad 41-2, which forms the electric signal output terminal coupled to the ground electrode 42, which forms the electric signal output terminal coupled to the ground electrodes 42 by way of the resistors (not illustrated), are arranged on one side which forms the substrate 2. On the other hand, the Mach-Zehnder optical waveguide 3 is formed close to the side opposite to the side at which the electrode pads 41-1 and 41-2 are formed. With this arrangement, it is possible to suppress the interference of the light as a form of waveguide securing the widths of the interference optical waveguides 3b-1 and 3b-2, and it is also possible to decrease the device size.

In this instance, as described with reference to FIG. 7 and FIG. 8, modified examples of the optical waveguide device 10 according to the second embodiment (in each of the drawings, the reference characters similar to those of FIG. 5 indicate the similar parts) are illustrated. In FIG. 9, a modified example of the optical waveguide device 1 according to the first embodiment is illustrated (in FIG. 9, the reference characters similar to those of FIG. 1 indicate the similar parts). These modified examples each can be similarly applied to the optical waveguide device (the reference character 1 in FIG. 1, the reference character 11 in FIG. 10, or the like) according to the other modifications.

Further, the constructions according to the above described embodiments and those of the modified examples can be provided in combination with one another, appropriately. For example, the construction of the periodical propagation characteristics region 60 can be applied to that of the periodical polarization characteristics region (see the reference characters 6 and 16) according to the third embodiment.

Yet further, the disclosure of the already described embodiment makes it possible for the ordinarily skilled in the art to manufacture the device according to the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. An optical waveguide device, comprising:
a substrate having electro-optic effects;
a Mach-Zehnder optical waveguide formed on the substrate; and
a signal electrode formed on the substrate, which signal electrode applies electric field to the Mach-Zehnder optical waveguide,
the signal electrode being formed in an integrated manner such that an electric signal for applying the electric field travels from an upper part of one of two interference optical waveguides, which form the Mach-Zehnder optical waveguide, to an upper part of the other one of the interference optical waveguides, and
a periodical polarization characteristics region, in which opposite regions with respect to one another are alternately arranged, being provided for a part of the other one of the interference optical waveguides on the substrate.

2. The optical waveguide device as set forth in claim 1, wherein the signal electrode comprises:
a first electrode unit formed at the upper part of the one of the interference optical waveguides, in which first electrode unit the electric signal proceeds in a first direction;
a second electrode unit formed at the upper part of the other one of the interference optical waveguides, in which second electrode unit the electric signal proceeds in a second direction that is opposite to the first direction; and
a third electrode unit which couples a downstream position in the direction in which the electric signal proceeds to an upstream position in the direction in which the electric signal proceeds in the second electrode unit.

3. The optical waveguide device as set forth in claim 1, wherein the periodical polarization characteristics region is constructed in such a manner that a first polarization region with first polarization characteristic and second polarization region with second polarization characteristic, which is opposite to the first polarization characteristic, are alternately arranged over the substrate on which the other one of the interference optical waveguides is formed.

4. The optical waveguide device as set forth in claim 3, wherein the length of the first or the second polarization region in the most downstream part in the optical propagation direction in the other one of the interference optical waveguides is substantially half the length of each polarization region formed in an upper stream part in the optical propagation direction than the polarization region.

5. The optical waveguide device as set forth in claim 3, wherein if a construction thereof is given such that an electric signal at a frequency of f, as the electronic signal, is supplied to the signal electrode, and assuming that the velocity of light propagating through the other one of the interference optical waveguides is Vo and also that the velocity of light propagating through an upper part of the other one of the interference optical waveguides in the signal electrode is Vm and also that the distance between the two interference optical waveguides is Li, the substantial length of a polarization region in the most downstream part in the optical propagation direction in the other one of the interference optical waveguides is given as VoVm/(4(Vm+Vo) f)−Li, and the substantial length of each polarization region formed in an upper stream part of in the optical propagation direction than the polarization region in the most downstream part in the optical propagation direction is given as VoVm/(2(Vm+Vo)f).

6. The optical waveguide device as set forth in claim 3, wherein the sum of the lengths of the polarization regions with the first polarization characteristic or the lengths of the polarization regions with the second polarization characteristic, which forms the periodical polarization characteristic region, is substantially half the length of the other one of the interference optical waveguides.

7. The optical waveguide device as set forth in claim 1, wherein a construction thereof is given as an RZ light pulse modulator, which generates an RZ light pulse having a frequency equivalent to the frequency of the electric signal or the frequency double the electronic signal by modulating input light.

8. The optical waveguide device as set forth in claim 3,
wherein if a construction thereof is given such that an electric signal at a frequency of f, as the electronic signal, is supplied to the signal electrode, and assuming that the velocity of light propagating through the other one of the interference optical waveguides is Vo and also that the velocity of light propagating through an upper part of the other one of the interference optical waveguides in the signal electrode is Vm, the periodical polarization region has a construction such that the substantial lengths of the polarization regions in the most downstream part and the most upstream in the optical propagation direction in the other one of the interference optical waveguides is VoVm/(4 (Vm+Vo)f), and
wherein the length of each polarization region arranged in the other one of the interference optical waveguides, from a downstream part thereof in the optical propagation direction to an upstream part thereof, is distributed between VoVm/(2(Vm+Vo)(f+df)) and VoVm/(2(Vm+Vo)(f−df)) based on a frequency variation df of an electronic signal supplied as the electronic signal.

9. The optical waveguide device as set forth in claim 1, wherein a construction thereof is given such that the velocity of an electric signal propagating through an upper area of the other one of the interference optical waveguides in the signal electrode is changed in the optical propagation direction of the other one of the interference optical waveguides.

10. The optical waveguide device as set forth in claim 9, wherein assuming that the periodical cycle of the polarization characteristic which the periodical polarization characteristics region has is Ldi, the velocity of the electric signal varies between 2Ldi(f−df) Vo/(Vo−2Ldi(f−df)) and 2Ldi(f+df)/(Vo−2Ldi(f+df)) based on the frequency variation df of the electric signal.

11. The optical waveguide device as set forth in claim 9,
wherein ground electrodes formed at specific intervals along the exterior fringe of the signal electrode are provided for the substrate, and
wherein the width of the interval between the signal electrode and the ground electrodes has a shape which changes in the optical propagation direction.

12. The optical waveguide device as set forth in claim 9, wherein the region of the signal electrode formed in an upper part of the other one of the interference optical waveguides is constructed in such a manner that the thickness and the width of the region in the optical propagation direction change in the optical propagation direction.

13. The optical waveguide device as set forth in claim 9, wherein a buffer layer is interposed between the substrate and the signal electrode and also wherein the thickness of a region between the other one of the interference optical waveguides and the signal electrode varies in the optical propagation direction in the other one of the interference optical waveguides.

14. The optical waveguide device as set forth in claim 9,
wherein a ridge waveguide is provided as the interference optical waveguide of the one of the interference optical waveguides by forming grooves on both sides of the one of the interference optical waveguides on the substrate, and
wherein the grooves are made in such a manner that the width of the ridge waveguide varies in the optical propagation direction.

15. The optical waveguide device as set forth in claim 1, wherein ground electrodes formed at specific intervals along the exterior fringe of the signal electrode are provided for the substrate.

16. The optical waveguide device as set forth in claim 15, wherein a distance between the two interference optical waveguides is made to be three times or more that of the specific interval between the signal electrode and the ground electrodes.

17. The optical waveguide device as set forth in claim 15, wherein the ground electrodes are formed in a region sandwiched between the two interference optical waveguides and also in outer regions of the two interference optical waveguides, and also, the region sandwiched between the two interference optical waveguides are coupled to the outer regions of the two interference optical waveguides by bonding.

18. The optical waveguide device as set forth in claim 1, wherein the signal electrode has an electric signal input terminal through which the electronic signal is input to the one of the interference optical waveguides, and also, an electric signal output terminal which outputs the electric signal that travels through the other one of the interference optical waveguides, and also, the electric signal input terminal and the electric signal output terminal are arranged on one side of the substrate.

19. The optical waveguide device as set forth in claim 1,
wherein the signal electrode comprises: a fourth electrode unit in which the electric signal proceeds in an upper part of the other one of the interference optical waveguides in a first direction; a fifth electrode unit, formed in the upper part of the one of the interference optical waveguides, in which the electric signal proceeds in the first direction; a sixth electrode unit which couples a proceed direction downstream position in the electric signal in the fourth electrode unit and a proceed direction upstream position of the electric signal in the fifth electrode unit together; a seventh electrode unit, formed on the position depart from the position at which the fourth electric unit in an upper part of the other one of the interference optical waveguides, in which the electric signal proceeds in a second direction, which is opposite to the first direction; and an eighth electrode unit which connects a proceed direction downstream position of the electric signal in the sixth electrode unit and a proceed direction upstream position of the electric signal in the seventh electrode unit together and also
wherein regions on the substrate at which the fourth electrode unit and the fifth electrode unit are formed as regions having polarization characteristics opposite with respect to one another, and the periodical polarization characteristics region is provided for a region on the substrate at which the seventh electrode unit is formed.
